(19) United States
(12) Patent Application Publication
(10) Pub. No.: US 2017/0361888 A1
(43) Pub. Date: Dec. 21, 2017

(54) Quick-Release Rigid Deflector for Motorcycles

(71) Applicants: Mark Lawrence, West Sacramento, CA (US); Steven Robert Lawrence, West Sacramento, CA (US)

(72) Inventors: Mark Lawrence, West Sacramento, CA (US); Steven Robert Lawrence, West Sacramento, CA (US)

(21) Appl. No.: 15/187,753

(22) Filed: Jun. 20, 2016

(51) Int. Cl. B62J 17/06

(52) U.S. Cl. CPC B62J 17/06; B62K 2206/00; B60Y 2200/12; B60Y 2410/114

(57) ABSTRACT

A quick-release rigid deflector for a motorcycle is a system with a rigid body (1), which deflects oncoming wind, debris, and rain from the motorcycle and rider(s). The system is mounted so that it can be quickly attached or removed without excessive time or effort immediately before riding at the discretion of the rider.

### BACKGROUND OF THE INVENTION

Windshields and deflectors are common devices that have been used on motorcycles and bicycles since the 19th century. They are used to protect the rider from uncomfortable buffeting, wind, weather, and debris. Motorcycles were first fitted with windshields and deflectors shortly after their invention. It quickly became apparent that it is not always desirable to have a windshield on the vehicle for aesthetics or to prevent air stagnation when it is hot, so detachable windshields were invented. It further became apparent that detaching windshields rapidly was desirable so that a rider may decide immediately before departing based on that day's weather, and so quick-release windshields were invented. However similar principles have never been applied to rigid deflectors.

The present invention refers specifically to releasable and not simply detachable rigid deflectors. In this context, releasable is used to mean a quick-release system which can be quickly removed from or attached to a motorcycle. Conversely, detachable is used to mean a system which can be removed, but with such excessive time and effort that it is undesirable to remove or attach the device immediately before riding.

U.S. Pat. No. 4,958,761 discloses a shield which attaches to the cross member portion of the handlebars of a bicycle. It is used for shielding bicycles during transportation and is neither for motorcycles nor for use on a vehicle while it is being ridden. It uses a hook and compression ratchet as a releasement mechanism.

U.S. Pat. No. 7,753,430B1 discloses a deflector which attaches to the crash bars of a motorcycle. It uses a clamp and bolts with wing nuts as a detachment mechanism. To remove the device the user would need to use get a proper size wrench, remove multiple bolts, and then put the tools away and store the bolts. It does not feature a quick-release mechanism, nor is it usable as a generic releasable deflector, merely a detachable deflector for a specific part of a motorcycle.

U.S. Pat. No. 5,853,217A discloses a releasable windshield for a motorcycle. It describes a hook mechanism that is releasable, but does not anticipate a releasable deflector.

US 20,070,296,237A1 discloses another releasable windshield for a motorcycle. It describes a 10 different mechanisms, but it also does not anticipate a releasable deflector.

U.S. Pat. No. D 438,496S1 discloses a releasable soft guard that provides a similar function, but is not a releasable rigid deflector and does not anticipate one. It uses a buckle, buttons, and straps as a releasement mechanism. The splash guard it depicts is made of a soft material such as leather and does not provide the protection of a rigid deflector. It is limited to webbing the crash bars and could not extend past that as designed without flopping over. It is also missing other advantages of a rigid body such as the ability to come in various sizes and shapes, modularity or attachability, and paintability.

### SUMMARY OF THE INVENTION

The present invention allows for a rigid deflector to be releasably attached to a motorcycle. When attached it can make the ride more comfortable for the rider, and protect the rider, his or her gear, and the motorcycle itself from damage and soiling. However, it can also add weight, make the bike look worse, or reduce airflow and make it uncomfortably hot. The present invention can be released or attached to the bike immediately before riding based on that day's weather.

A rigid deflector has a body made of a firm material, such as plastic or metal, which deflects oncoming wind, debris, and rain away from the motorcycle and rider as the motorcycle moves forward. A deflector may be planar, curved, or a complex shape that may be either functional or decorative, and may or may not resemble a fairing, a handlebar guard, a panel, a plate, a shield, or a wing. A deflector may be attached to any part or accessory of a motorcycle including, but not limited to the belly, crash bars, fairing, forks, gas tank, handle bars, or windshield itself. A deflector is not the windshield of a motorcycle. A windshield is rigid body, like a deflector, but positioned in the front of the motorcycle, centered, and high enough to deflect wind away from the torso and head of the rider.

The present invention attaches using a releasable mechanism such as clamps, claws, hooks, a lock and key, lock pins, push rivets, quick-release levers, toggle latches, or sliding on. It may attach with any releasement mechanism, which in this context means a detachment mechanism that does not take excessive time or effort. Excessive time or effort is such that releasing or attaching the device would make the rider substantially late to wherever he or she was going, if he or she didn't prepare extra time in advance to release or attach the deflectors. Excessive time or effort may be due to needing to retrieve, use, and put away hand tools such as screwdrivers or wrenches, but not using a quick releasement tool specifically for the device, such as a key. The present invention may engage into a fixture that is permanently attached to the motorcycle such that the rigid deflector releases from the fixture.

Other features and advantages of the invention will become apparent to those skilled in the art upon study of the following description and the accompanying drawings which are merely illustrative of such invention. It is also anticipated that other changes could be provided to achieve a similar functionality of the present invention.

### BRIEF DESCRIPTION OF THE DRAWINGS

FIG. 1 is a perspective view of a first embodiment of the present invention, which is installed on a motorcycle on the clutch lever side, as seen from the front of said clutch lever side.

FIG. 2 is a view of a second embodiment of the present invention from the same perspective as FIG. 1.

FIG. 3 is a front view of a third embodiment of the present invention.

FIG. 4 is a view of a fourth embodiment of the present invention from the same perspective as FIG. 1.

### DETAILED DESCRIPTION

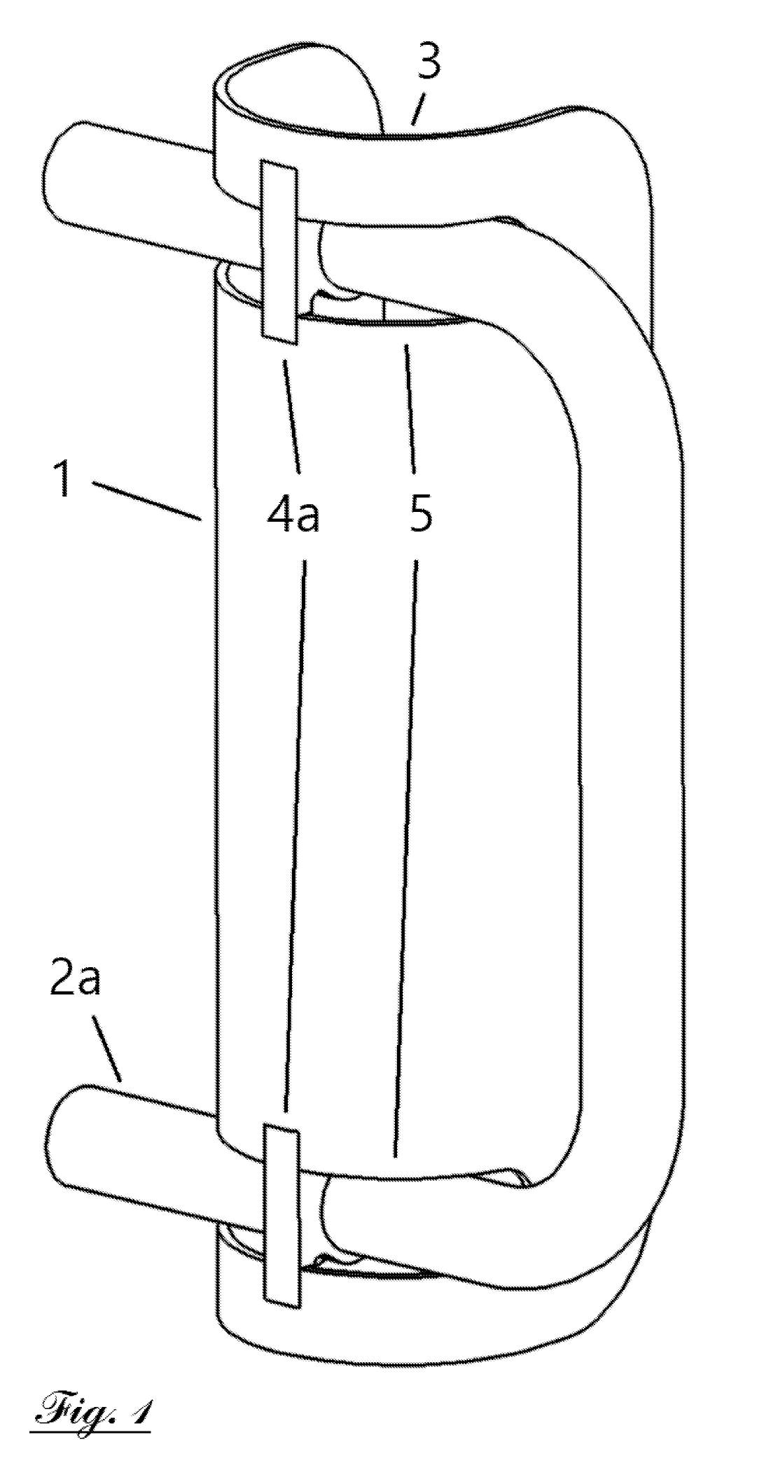

FIG. 1 depicts an embodiment of the present invention. A deflector 1 is attached to a crash bar 2a releasably. Said crash 2a bar fits into a set of grooves 5 in said deflector 1. Said deflector 1 releasably attaches to said crash bar 2a using a set of clamps 4a, which may disconnect, allowing said deflector 1 to be removed from the motorcycle. Said deflector 1 may have a curve 3 to protect from wind or objects coming from the side. In this embodiment said deflector 1 is made from a sheet of plastic which has said grooves 5 cut into it and is then bent to produce said curve 3. A standard releasement mechanism, such as said clamps 4a, is then coupled with said deflector 1 to provide releasement functionality. This has the advantages of providing a large amount of protection effectively, while being easily manufactured at a relatively low cost, and also being lightweight and aesthetically pleasing.

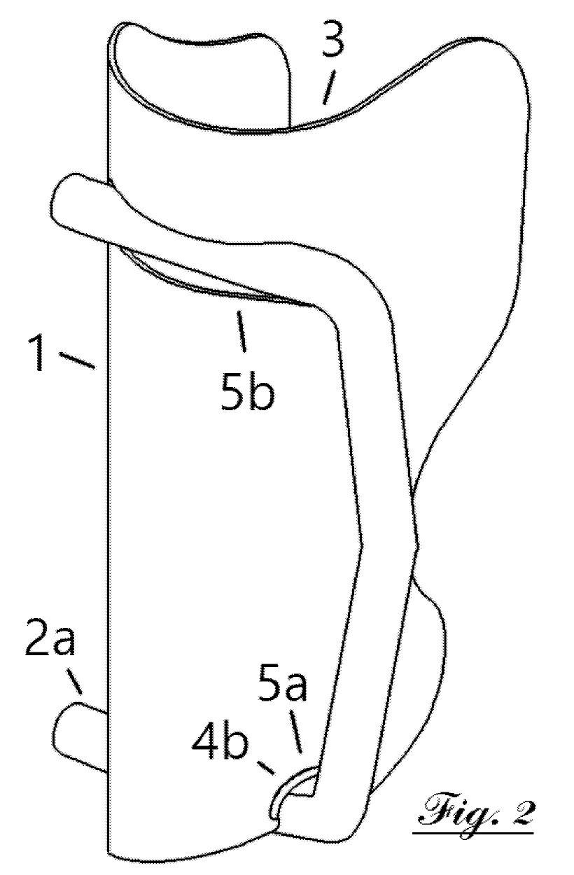

FIG. 2 depicts a second embodiment of the present invention. A deflector 1 is attached to a crash bar 2a releasably. Said crash bar 2a fits into an upper groove 5b and a lower groove 5a, which in this embodiment are shaped such that said groove 5a can be lowered onto the bottom portion of said crash bar 2a at an angle, and then said deflector 1 can be rotated so that the upper portion of said crash bar 2a snaps into said upper groove 5b. Said groove 5a has a grommet 4b which allows said deflector 1 to snap onto said crash bar 2a. This embodiment has the advantage of being even cheaper to produce, and having a simpler and quicker releasement mechanism than some other embodiments.

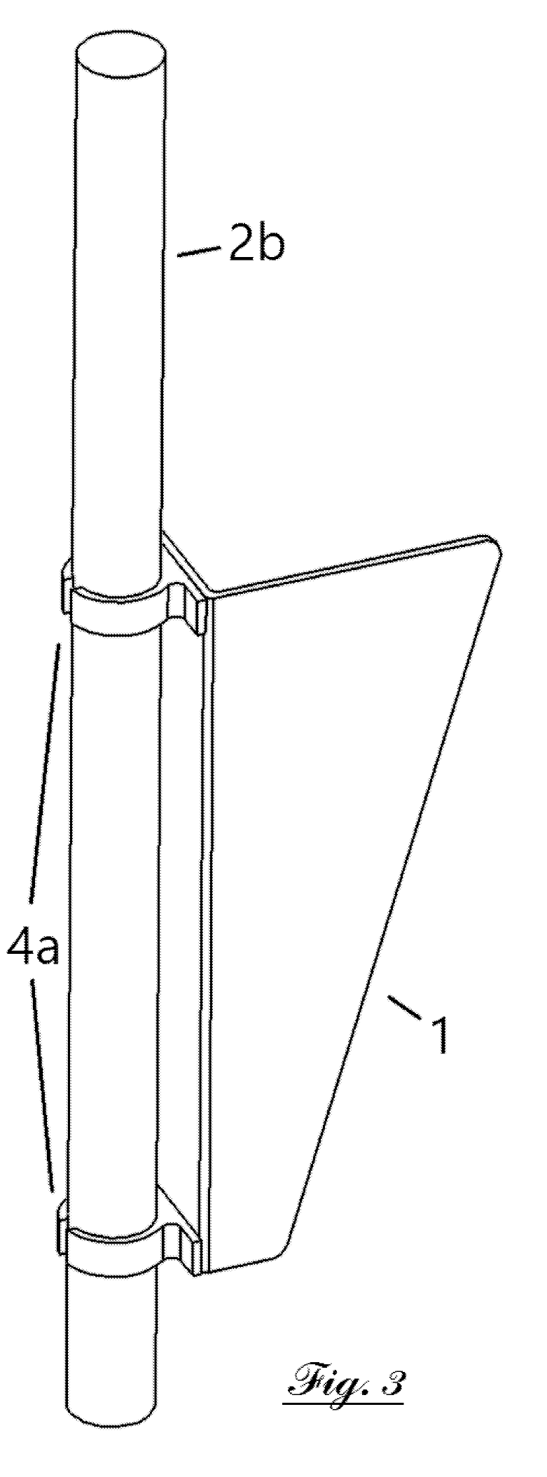

FIG. 3 depicts a third embodiment of the present invention. A deflector 1 is attached to a fork 2b releasably. Said deflector 1 has a set of clamps 4a to connect it to said fork 2b. This has the advantages of providing protection in a forward location, and being mountable on any motorcycle with said fork 2b.

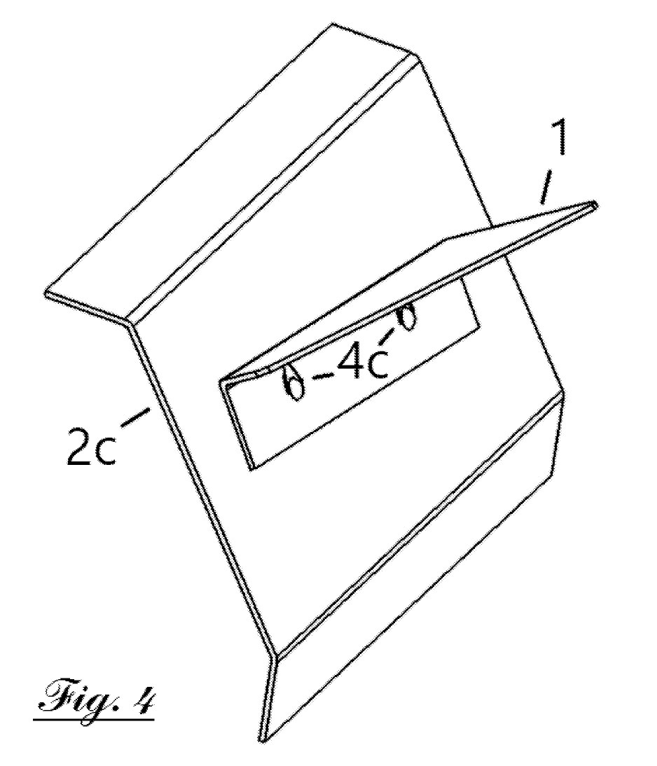

FIG. 4 depicts a fourth embodiment of the present invention. A deflector 1 is attached to an arbitrary surface of a motorcycle 2c. Said deflector 1 has a set of turn fasteners 4c to connect it to said surface 2c. This has the advantage of being placeable nearly anywhere on said surface 2c to block wind, such as that that would normally go past the primary rider's thighs and disturb the passenger of said motorcycle.

1. A quick-release deflector for a motorcycle comprising:
a rigid body that deflects air and its contents, such as debris or rain, away from said motorcycle, a rider, or both that is not the windshield; and
a mechanism to releasably attach said deflector to said motorcycle, an accessory of said motorcycle, or both, which allows for a user to remove or attach said deflector without excessive time, or excessive effort, or both.

2. The system according to claim 1, wherein said deflector attaches to the crash bars of said motorcycle.

3. The system according to claim 2, wherein said deflector uses a release mechanism including sliding, or rotating, or both into place.

4. The system according to claim 1, wherein said deflector attaches to the fairing of said motorcycle.

5. The system according to claim 1, wherein said deflector attaches to the gas tank of said motorcycle.

6. The system according to claim 1, wherein said deflector attaches to the forks of said motorcycle.

7. The system according to claim 1, wherein said rigid body deflects air away from the legs of said rider.

8. The system according to claim 1, wherein said rigid body comprises a wing shape and mounts directly below the mirrors.

9. The system according to claim 1, wherein said rigid body is made of a partially or completely transparent material.

10. The system according to claim 1, wherein said deflector attaches by sliding on, or rotating on, or both.

11. The system according to claim 1, wherein said deflector attaches to at least one fixture which is installed on said motorcycle.

12. The system according to claim 1, wherein said deflector attaches with at least one clamp.

13. The system according to claim 1, wherein said deflector attaches with at least one claw.

14. The system according to claim 1, wherein said deflector attaches with at least one quick-release lever.

15. The system according to claim 1, wherein said deflector attaches with at least one toggle latch.

16. The system according to claim 1, wherein said deflector attaches with at least one turn fastener.

17. A method for attaching a rigid deflector to a motorcycle in a manner that can be released comprising the steps:
providing a motorcycle;
providing a rigid body that deflects air and its contents, such as debris or rain, away from said motorcycle, or the rider, or both that is not the windshield;
engaging a releasable attachment mechanism to affix said deflector to said motorcycle, or an accessory of said motorcycle, or both.

18. The method of claim 17 further comprising the steps of:
disengaging said releasable attachment mechanism;
removing said deflector.

19. The method of claim 17 further comprising the initial step of installing hardware to said motorcycle, or an accessory of said motorcycle, or both that said mechanism engages to.

20. A means for selectively providing protection on a motorcycle from air and its contents, such as debris or rain, whereby the protection can be activated by releasably attaching a deflector.
